(19) United States
(12) Patent Application Publication
(10) Pub. No.: US 2005/0243924 A1
(43) Pub. Date: Nov. 3, 2005

(54) Device for scrambling mpeg-4-type audio-visual and multimedia content

(75) Inventors: Daniel Lecomte, Paris (FR); Pierre Sarda, Asnieres-Sur-Seine (FR)

Correspondence Address: IP GROUP OF DLA PIPER RUDNICK GRAY CARY US LLP, 1650 MARKET ST, SUITE 4900, PHILADELPHIA, PA, 19103, US

(73) Assignee: MEDIALIVE, Paris (FR)

(21) Appl. No.: 10/523,675

(22) PCT Filed: Aug. 6, 2003
(86) PCT No.: PCT/FR03/02477

§ 371 Date: Mar. 29, 2005

(30) Foreign Application Priority Data
Aug. 6, 2002 (FR) 02/10002

(51) Int. Cl. H04N 7/12

(52) U.S. Cl. 375/240.16; 375/240.24; 375/240.25

(57) ABSTRACT

A process for distributing video sequences according to a nominal stream format that describes a plurality of audiovisual scenes, each scene formed from a plurality of hierarchical audiovisual objects and a describer of the hierarchy and spatial and temporal relationships between the objects, with each video object comprising at least one digital plane P, including analyzing the nominal stream to generate a first modified stream having a format ofthe nominal stream and having planes P, B or S (GMC) containing macroblocks of which all or part of values of movement vectors were modified, generating a second stream with any format comprising digital information to permit reconstruction of the modified planes, separately transmitting the two streams from the server to addressed equipment, and calculating a synthesis of a stream to the nominal format on the addressed equipment as a function of the first and second streams.

The present invention relates to the scrambling of any multimedia program or sequence using a nominal stream format of the MPEG-4 type in order to realize conditional access, secure broadcasting, recording control, private copy and the viewing of these multimedia programs or sequences by authorized users and proposes a secure system for the processing, access, broadcasting, delivery, recording, private copy, viewing and management of program rights and of interactive video or multimedia sequences.

The general problem is to make available a device capable of transmitting in a secure manner a unit of high quality visual films in a format of the MPEG-4 type directly to a television screen and/or to be recorded on the hard disk of a box connecting the communication network to a monitor screen, television screen, video projector or movie screen while preserving the audiovisual quality yet avoiding any fraudulent use such as the possibility of making pirate copies of audiovisual films or programs recorded on the hard disk of the set-top box.

The invention also allows a total control over the use of copies and rights attached to the works distributed in this manner.

It is possible with current solutions to transmit audiovisual films and programs in digital format via broadcasting networks of the microwave, cable satellite, etc. type or via telecommunication networks of the DSL type (digital subscriber line) or BLR type (local radio loop), via DAB networks (digital audio broadcasting) or via digital telecommunication networks (GSM, GPRS, UMTS). In addition, in order to avoid the pirating of works broadcasted in this manner, the latter are frequently encrypted by various means well known to an expert in the art.

Patent PTC WO00165762 known in the state of the art describes a conditional access system in which a headend transmits content to one or several receivers in encrypted transport streams. This system offers a multi-layer security architecture that renders the system resistant to key replay attacks. If one layer is distorted the following layer remains intact. A first layer prevents the recording of encrypted keys while protecting these encrypted keys of the users and while encrypting the path from the conditional access module of the receiver running to the transport decryption module. A second layer prevents a recorded key from being rerun on a receiver at the level of the transport decryption module of a second receiver. A third layer prevents the user from decrypting transport streams without the encrypting module while encrypting the stream a second time before its passage into any memory or any processor accessible by a user. Event tables are transmitted with the non-encrypted transport stream for an immediate or encrypted use in order to prevent a non-authorized use.

The main disadvantage of this solution is that it is necessary to transmit not only the encrypted data to the users but also the decryption keys. The transmission of the decryption keys can take place before, at the same time as or after the transmission of the audiovisual programs. In order to increase the security and therewith the protection of audiovisual works against an ill-disposed use, the decryption keys as well as the decryption functions of the audiovisual decoders can comprise improved security means such as smart cards or other physical keys that can optionally be updated remotely.

Thus, the current solutions applied to a set-top decoder box with the possibility of local recording of audiovisual programs in digital format on any support of the hard disk type or some other type of memory offer an ill-disposed user the possibility of making non-authorized copies of programs recorded in this manner since at a given moment this user has, with his set-top decoder box which is associated or non-associated with smart card systems, all the information, software programs and data permitting the complete decryption of audiovisual programs. Precisely on account of the fact that he has all the data, the ill-disposed user has the possibility of making illegal copies without anyone noticing this fraudulent copying at the moment at which it is made.

One solution would therefore consist of transmitting all or part of a digital audiovisual program only on demand (video services on demand) via a broadband telecommunication network of the ADSL type, cable or satellite, without authorizing the local recording of audiovisual programs. Document WO0011871 (open entertainment) thus proposes a solution of distributing multimedia files on the request of the user. Its disadvantage resides in the performances of these networks, which do not allow continuous streams of several megabits per second to each user to be guaranteed, as required by MPEG-4 streams that require bands succeeding several tens of kilobits to several megabits per second.

Given these conditions, one solution consists in separating the stream into two parts, neither of which could be used by itself. Several patents have been filed with this in mind. Thus, document WO9908428 teaches a multi-applicative processing method of a localizable active terminal in which at least one connection is made with an identifiable program dedicated to the execution of an application, which program dictates its conditions of use to the terminal for making functions available. The terminal talks sporadically by using a connection with the managing center for realizing, if necessary, inputs and outputs of the capacities of the latter, which management center becomes a slave or does not become a slave of the terminal at the level of the application software relative to the entering program. This invention also relates to the process for identifying the program and the terminal in use. This process of the prior art divides the stream into a part serving to identify the user and a part that contains the program itself. In particular, this program is not unusable but only blocked by the first part.

On the other hand, document EP0778513 describes a process that permits the illegal use of information to be prevented by adding control information in order to verify the rights of the user. The system permits permanent knowledge of which part of the information is used and by which user and consequently whether this user is illegal or not. This process thus secures the data by adding additional information to it that adulterates the initial information.

Another solution known in the prior art is document U.S. Pat. No. 4,916,737, that proposes a system of scrambling and descrambling audiovisual streams using classic scrambling solutions but which regularly changes the descrambling keys or tables by means of a telephone connection to a server, identifying the appropriate code for each piece of addressed equipment. The importance of this process is to regularly change the descrambling keys (tables) stored in the rewritable memory of the addressed equipment in contrast to a system in which these keys are fixed. The server connects once a month to the set-top decoder box of the client, identifies it and rewrites the new tables.

This invention does not claim any innovative protection means but rather the protection is based on encryption keys that, although reinitialized periodically, remain the same for all the visual streams. In the case in which an ill-disposed person retrieves these keys, he would be able to visualize all the visual streams during their period of validity. Moreover, the process of this document applies to systems of broad broadcasting of televised programs in which the protected films are descrambled and visualized in real time on the client equipment and is therefore not applicable to services of video on demand since the possibility of storing the protected films on the addressed equipment is not treated.

Document WO0049483 proposes a process for creating a connection between the users and an editor of digital entities. The process comprises at least one of the following stages: The stage of subdividing this digital entity into two parts, the state of memorizing a part in a memory zone of a server connected to a computer network, the stage of transmitting the other part to at least one user with computer equipment, the state of connecting this computer equipment to this computer network, the state of establishing a functional connection between this first part and this second part. These processes and systems do not specify whether the memorized part on the server can be stored by the user, which would permit him to pirate this digital entity.

Patent WO197520 also presents methods, processes and devices for controlling the transmission and the recording of digital content of the MPEG-2 type. Nevertheless, this patent does not present any specific character for audiovisual documents of the MPEG-4. Moreover, the method is totally ineffective for low-bandwidth telecommunication networks because it substitutes all or part of the I images whose weight in bytes is very expensive during the transmission of the second stream.

Finally, in this approach the closest state of the art is found in the patents of HyperLOCK Technologies, and of which the most pertinent one is document U.S. Pat. No. 05,937,164. This invention makes use of the solution consisting of separating the stream into two parts of which the smallest one comprises information necessary for using the largest one. Nevertheless, this patent is not sufficient for corresponding to the identified problem. In fact, the suppression of one part of the stream adulterates the format of the stream and it can therefore not be recognized as a standard stream that can be used for general software applications. This process of the prior art requires a specific software at the same time on the server side for separating the two parts and another specific software assuring not only the reconstruction of the stream but also the acquisition of the main stream and its use according to a proprietary format for the solution. This proprietary format is not the initial format of the stream before separation into two parts in this known solution.

This company has also filed three other patents: Document U.S. Pat. No. 5,892,825 recapitulates the preceding patent but in a less extensive framework because the streams in it are always encrypted. Document U.S. Pat. No. 6,035,329 is based on the same principle and relates to a process permitting the reading of a disk of the CD-ROM or DVD-ROM type conditioned on the identify-cation of rights by inserting a smart card on which the information necessary for reading is stored. This process is still insufficient for our problem because it does not guarantee that the modified stream has the same format as the original stream. Finally, document U.S. Pat. No. 6,185,306 relates to a process for transmitting encrypted data from a web site to a requesting computer. However, this process allows the user to have all the tools necessary to copy the data at a given moment.

Document EP0949815 is also in the prior art and relates to a process and a system for protecting video stream of the MPEG type, comprising decoding modules, arrangement tables and rearrangement tables and consists of inverting or permuting the order of the macroblocks or of the slices in the images in order to degrade the visual quality of the resulting stream, thus creating the protection of this stream and guaranteeing that the resulting stream respects the norm of the original stream, thus allowing the protected stream to be read by every player capable of accepting the original format without it being disturbed or damaged. A first embodiment comprises the protection arrangement table stored on the module producing the protected stream and an adequate rearrangement table is present on the decryption module. Another variant is to construct, starting from the protection table, a rearrangement table that is then sent to the decryption module at the same time as the scrambled data. A third variant consists in that the decryption module produces the rearrangement table from information of the arrangement table sent by the encryption system.

However, the process applies solely to MPEG streams containing natural video and does not refer to streams of the MPEG-4 type. The variant of this invention which permutes slices is not applicable to streams of the MPEG-4 type because the slice structure does not exist in streams of the MPEG type. Moreover, no mention is made concerning the protection of movement vectors.

This invention does not completely address the security problems but rather proposes a classic scrambling solution bringing about the permutation of elements constituting the video stream, but the protective stream contains all the elements constituting it, which is integrally sent to the user. If an ill-disposed person takes possession of the arrangement tables or rearrangement tables the stream can be descrambled. Moreover, the protected data and the arrangement tables or the rearrangement tables are sent by the same path as the initial protected stream and in a variant the protected data and the information for the rearrangement tables are sent by the same path and at the same time.

In order to correct these various faults the invention relates to a process for the distribution of video sequences according to a nominal stream format constituted by data representing a succession of audiovisual scenes constituted by audiovisual objects forming a hierarchy according to a script describing their relations in space and in time, each of which comprises at least one P plane as is the case with the MPEG-4 norm.

As is well known to the expert in the art, the MPEG-4 norm introduces the notion of video object (VO for “video object”), e.g., a person or a passing car. In the simplest case the VO is a rectangular object. The MPEG-4 norm also introduces the video object layer (VOL). This latter is composed by groups of video object planes (GOV) that contain several video object planes (VOP) that represent a video object at a given moment. This breakdown into object greatly facilitates the interactivity and it becomes easier to obtain information about an object (the player or the passing car).

The basic principle of MPEG-4 compression is based on the content. It is thus necessary to separate the background from the animated objects. One of the characteristics of MPEG-4 is to separate well the objects and the background of a scene in order to then obtain advantages from this for the compression and the supplementary functionalities which this entrains. This permits, e.g., during a pan the complete background to be transmitted only once and the animated objects to be sent separately.

An audiovisual scene coded MPEG-4 is described as a unit of individualized and independent elements. It comprises base components regrouped by type. These groups correspond to the branches of a projected tree where each leaf represents a simple base element. Thus, an audiovisual scene of the MPEG-4 type should be understood as a composition of audiovisual objects according to a script describing their spatial and temporal relationships. The functionalities of MPEG-4 require a representational environment or an architecture that uses a data structure different from MPEG-1 and MPEG-2 because the significant parts of the visual information must be assessable for interaction and manipulation. In the remainder of the text the term VOP (video object plane) corresponds to a video component with an arbitrary shape. The VOP definition plane has the task of defining the significant objects of the scene with which independent interactions and manipulations will be possible. This means that these objects are represented in such a manner as to supply an access that is simple and preferably independent of the other objects of the scene. Nevertheless, the different VOP's do not necessarily have the same spatial and temporal resolutions.

Moreover, in order to increase the possibilities of manipulation, hierarchies of VOP's associated with different degrees of accessibility are also taken in account.

All this permits the user to be able to interact with the objects of the scene. A few possible manipulations follow:
Modification of the spatial position of an object (VOP) in the scene,
Application of a spatial factor of scale to an object in the scene,
Change of the speed with which an object moves in the scene,
Addition of objects,
Elimination of an object from the scene.

In the MPEG-4 norm the information about the shape, movement and texture of the VOP's are coded and the VOL (video object layer) layers separated in order to permit the separate decoding of the VOP's. With MPEG-4 the rectangular image is only a particular case of coding multiple VOP's as an image with an arbitrary shape.

The MPEG-4 VM (MPEG-4 video verification model) makes use of an identical algorithm in order to code information about the shape, movement and texture in each layer. However, the information about the shape is not transmitted if the sequence to be coded contains only standard images with a rectangular form. In this instance the video coding algorithm MPEG-4 has a structure similar to the MPEG-1 and MPEG-2 algorithms. This is suitable for applications that require great coding efficiency without requiring extensive functionalities based on the content.

The compression algorithm MPEG-4 VM is based on the hybrid technique of the DPCM/transform already used by the MPEG-1 and MPEG-2 norms.

The first VOP of each GOV is coded in mode I. Each of the following images is coded using the prediction inter-image (P-VOP). Only the data of the closest image previously coded is used for the prediction. The support of the B-VOP is added to it. The coding process is the same as that of the standard MPEG-1 and MPEG-2.

In general, the input images that are to be coded for each VOP layer are of an arbitrary shape and the position and the shape of the images vary in time with respect to a reference window. In such a case MPEG-4 VM introduces the concept of VOP reference window with a macroblock format adaptable to the form. All the VOL layers that are to be coded for an input video sequence are defined relative to the reference window, whose form is constant.

The information in the form of a VOP is coded before the coding of the position vectors based on the macroblock format of the VOP and can be used as well for the encoding as for the decoding. In the following stages of the process only the information concerning the movement and the texture of the blocks of the macroblock are coded (which comprises the standard macroblocks and the contour macroblocks).

In its most general sense the invention relates to a process for the distribution of video sequences according to a nominal stream format intended to describe a plurality of audiovisual scenes, each scene being constituted by a plurality of hierarchical audiovisual objects and by a describer of this hierarchy and spatial and temporal relationships between these objects with each video object comprising at least one digital plane P, characterized in that an analysis of the stream is carried out before the transmission to the client equipment in order to generate a first modified stream presenting the format of a nominal stream, and a second stream with any format, comprising digital information suitable for permitting the reconstruction of these modified planes, that the two streams generated in this manner are then transmitted separately from the server to the addressed equipment and that a synthesis of a stream to the nominal format is calculated on the addressed equipment as a function of this first stream and of this second stream.

This synthesis advantageously produces a stream that is rigorously identical to the original stream, that is to say that the process is without loss.

In a particular embodiment of this process each video object comprises at least one plane N and the data representing this plane is calculated as a function of the differences between this plane N and at least one other plane.

This first stream advantageously presents modified planes N.

According to an embodiment of this process the data of at least one plane N is calculated by a compensation of the movement of this plane N relative to the preceding plane N. Plane N is then called plane P (predicted).

According to another embodiment of this process the data of at least one plane N is calculated by compensation of the movement of this plane N relative to preceding and following planes N or P. Plane N is then called plane B (bidirectional).

The format of the nominal stream is advantageously defined by the norm MPEG-4.

In an embodiment of this process this first stream presents modified planes P.

In another embodiment of this process this first stream presents modified planes B.

For an expert in the art video streams of the MPEG-4 type break down in the form of a succession of plane I, P, B or S. Planes I are called Intra. These are reference planes, with an increased size, and do not contain information related to the movement. Planes P are called predicted. They are related to the planes preceding them (planes I and/or P) by movement vectors in a single direction called forward. Planes B are called directional. The are connected to planes I and/or P preceding them and following them by movement vectors in the two directions (forward and backward).

Moreover, one of the characteristics of the MPEG-4 norm consists in breaking down a video scene into different video objects. The background can then be non-correlated with the other video objects and encoded in the plane form called Sprite (S-VOP). These planes can be static or mobile. In the latter instance one speaks of plane S-GMC for global motion compensation. These mobile planes also contain information connected to the movement.

The base unit for detecting the movement in a plane is the macroblock, which generally corresponds to a block of 16×16 pixels of the image (in specific instances the size can be different but this causes no problem for the invention). Each macroblock necessarily contains one type from the five different possible types: “Inter”, “Inter+Q”, “Inter4v”, “Intra” or “Intra+Q”. Each macroblock also contains other data necessary for decoding the information that follows. This data is differential movement vectors and blocks of luminance and of chrominance (4 blocks Y, 1 block Cb and 1 block Cr) each of which contains the differential coefficients DC and AC if they exist. They are used for reconstructing the coefficients DC and AC of the current block. The coefficient DC represents the continuous component issued from the transformation into discrete cosine of the values of the pixels of the bloc. The AC coefficients represent one or several non-zero horizontal and/or vertical spatial frequencies.

The movement vectors are reconstituted at the level of the decoder starting from differential movement vector values issued from the stream. These values are encoded in VLC, whose authorized values are normalized. They are the only values issued from the stream that permit the vector movements to be found.

Each of these values is decoded as a function of the movement type of the plane to which it belongs. This concerns forward, backward and direct. In each instance the differential movement vector is described by two values (in pixels). The first corresponds to the horizontal shifting and the second to the vertical shifting.

In the cases of forward and/or backward it is possible to have residual values for the horizontal and vertical data as a function of the configuration of the stream. These residual values are also used themselves to reconstruct the complete vector movement. This is not the case for the direct mode, that is used solely for planes B and allows the obtention of a compensation of direct bidirectional movement with the aid of a single differential vector movement.

There can be several successive differential values as a function of the stream, particularly in the instance in which the stream is interlaced and there is a field prediction, in which case there are two successive values of differential vector movement. For the S-GMC planes or the P planes (with macroblocks coded in Inter or Inter+Q) there is a single differential vector movement or two if the stream is interlaced and in field prediction. For the P planes with macroblocks coded in Inter4v there is a vector movement value for each block of non-transparent luminance up to four different values. In the case of a B plane, each macroblock can contain two differential vector movements, a forward and a backward one. If, in addition, the stream is interlaced and there is a field prediction, there are then four differential vector movements.

In the case of binary alpha blocks that are present in the video stream whose form is not rectangular, differential vector movements can also be decoded. There is only one differential vector movement in each BAB. The BAB or binary alpha blocks are groups of 16×16 pixels issued from the cropping of the limitation rectangle put in place for the shape coding for the video object. The horizontal and vertical values are coded in VLC and the authorized values are normalized.

The video streams advantageously contain differential vector movements whose transformation allows the stream to be efficiently protected by rendering it difficult to accept from the visual viewpoint for the human eye while assuring its viewing on every player of the MPEG-4 type.

### EXAMPLES OF EMBODIMENTS

Transforming these values while respecting the authorized VLC codes allows the rendering of a video stream to be very heavily corrupted. The visual effects are multiple: Separation or superpositioning of objects, flickering of the image, liquefaction effect or pixelation effect, inversion of movement, all of which renders the viewing of the stream very painful to the human eye. This analysis advantageously decides the differential vector movements to be modified as a function of the desired size for the second stream and of the desired degradation for this first modified stream; these modifications can be: Replace the differential vector movements of a plane P by differential vector movements of another plane P, invert two differential vector movements of the same plane P, invert two differential vector movements of two planes P of the same stream, replace the differential vector movements of a plane P by random values, invert the value of one or several bits well selected from the value of the differential vector movements of a plane P.

According to a particular embodiment of this process at least one plane B is modified in the same manner as planes P.

This analysis advantageously decides the planes P, B and S to be modified as a function of the desired size for this second stream and of the desired level of degradation for this first modified stream.

In a particular embodiment of this process the transmission of this first stream is realized via a physically distributed support material such as a CD-ROM, a DVD, a hard disk or a memory card of the flash memory type for example.

In another embodiment of this process the transmission of this first stream is realized via a broadband network (cable, satellite, optical fiber, microwave, DSL, DAB).

According to the implementation of this process the transmission of said second stream is realized via a cable network, a switched telephone network (analog or digital RTC), a mobile telephone network using the GSM, GPRS or UMTS norms, a BLR network (local radio loop) or via a network of the DSL type.

According to a particular variant of this process the transmission of this second stream is realized via a broadband network of the same type as the network used by the first stream, even via the same network.

According to a particular variant of this process the transmission of this second stream is realized by a memory card of the flash memory type or by a smart card.

The transmission of one of the two streams or of the two streams is advantageously encrypted.

According to the implementation of this process the two generated streams can be addressed to a single piece of equipment, to a group of equipment or to all the equipment.

According to a particular embodiment the reconstruction is conditioned by a transaction.

The reconstruction can also be authorized for a consultation of a private copy requested by the client.

In a general manner, the fact that the reconstruction is conditioned by the portal allows every operator of the service to manage all the rights attached to the audiovisual works.

Furthermore, the invention relates to a piece of equipment for producing a video stream for carrying out this process comprising at least one multimedia server containing the original video sequences and characterized in that it comprises a device for analyzing the video stream coming from the server in order to generate the two streams.

This equipment advantageously comprises a memory for recording a marker “private copy” indicating the rights of each user for each sequence: Private copy can be viewed an unlimited number of times, private copy can be viewed a limited number of times and what number, private copy forbidden.

Moreover, the invention relates to a piece of equipment for using a video stream for carrying out this process comprising a standard stream decoder, at least one recording interface (hard disk, memory of the flash memory type) intended to store the content of said first stream and/or a disk player (CD, DVD, etc.),and at least one display interface (standard screen, wireless screen, video projector), characterized in that it comprises means for the recomposition of the original stream from the two streams.

According to a particular embodiment this means is a software application installed on the equipment.

According to another embodiment this means is a fixed electronic device.

According to another embodiment this means is a portable (mobile) electronic device with its incorporated screen.

According to an embodiment in which the equipment is installed on a computer this means uses a resource specific to the product (card) in order to avoid the copying of the temporary information of the second stream onto a permanent support.

This recording interface advantageously also stores a marker “private copy” related to said first stream indicating for this sequence the rights of the user: Private copy can be viewed an unlimited number of times, private copy can be viewed a limited number of times and what number, private copy forbidden.

The equipment advantageously comprises a smart card reader permitting the identification of the user.

The equipment advantageously comprises a smart card reader containing the software applications.

The equipment advantageously comprises a smart card reader containing the data of said second stream for a given content.

Finally the invention relates to a system for transmitting a video stream, characterized in that it comprises equipment for producing a video stream, at least one piece of equipment for using a video stream, and at least one communication network between the production equipment and the piece(s) of equipment for use.

The present invention will be better understood upon reading the following description of a non-limiting embodiment with reference made to the attached drawings.

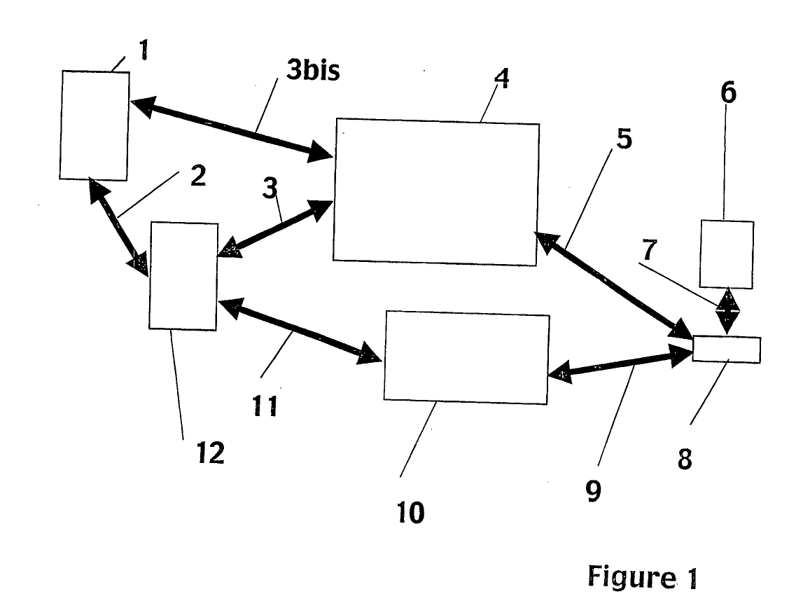

FIG. 1 describes the total architecture of a system for carrying out the process in accordance with the invention.

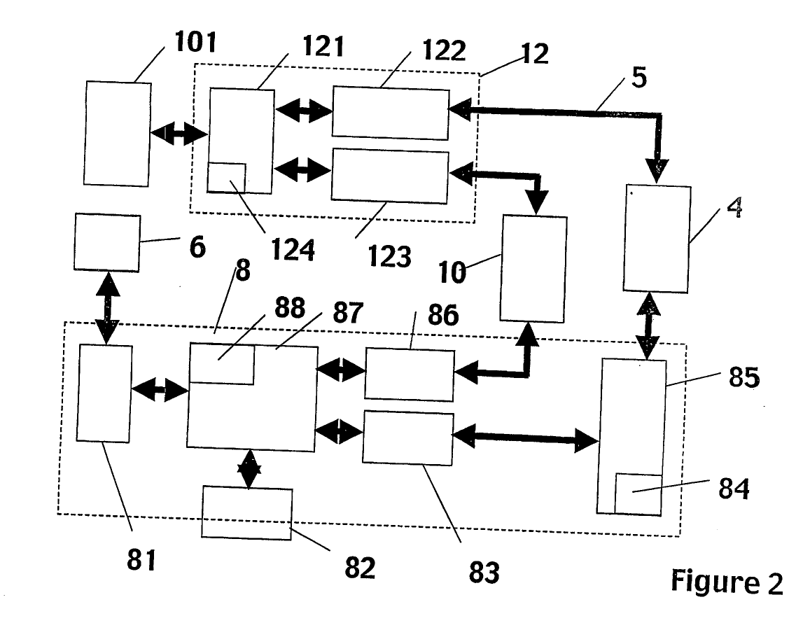

FIG. 2 represents a particular embodiment of the system for analyzing and synthesizing the stream in conformity with the invention.

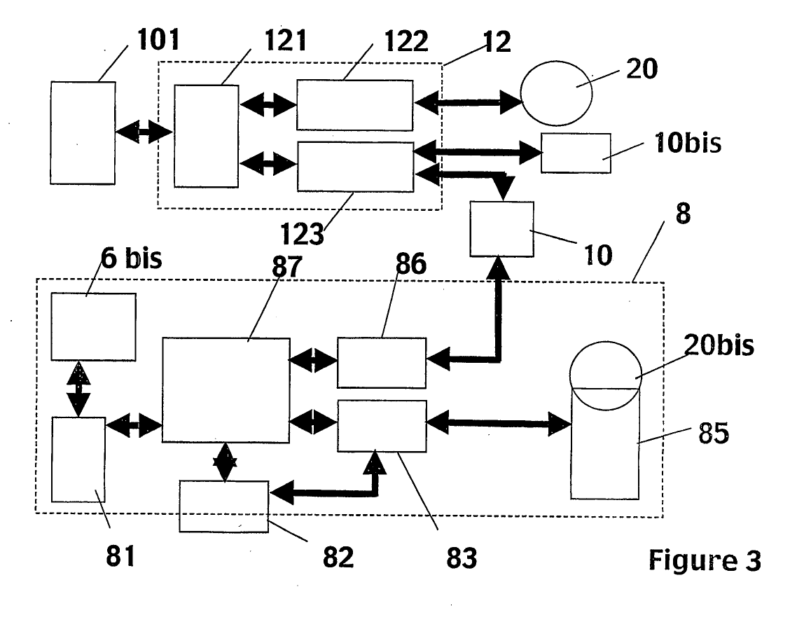

FIG. 3 represents a particular embodiment of the system for synthesizing the stream in conformity with the invention.

The invention relates to a stream of data with a nominal format, especially but not exclusively a stream of the MPEG-4 type. The format of the audiovisual stream used must have the following characteristics:

This format must break the data down into frames and each frame comprises a complete plane I and at least one plane P calculated while coding the differences (compensation of movement) between this plane [sic−frame?] and the preceding plane I or P.

Each frame optionally comprises at least one plane B calculated while coding the differences (compensation of movement) between this plane [sic−frame?] and the preceding and following planes I and/or P.

The invention relates to a stream of data with a nominal format, especially but not exclusively a stream of the MPEG-4 type. The format of the audiovisual stream used must have the following characteristics:
This format must break the data down into frames and each frame comprises at least one plane P.
Each plane P contains differential movement vectors between the different blocks and/or macroblocks of planes P.

In the following description the example relates to an MPEG-4 stream without this constituting a limitation of the scope of protection.

The general principle of a process for securing a video stream is revealed in the following. The objective is to authorize the on-demand and à-la-carte video services via all these broadcasting and local recording networks in the digital set-top decoder box of the user. The solution consists in permanently retaining a part of the audiovisual recorded program outside of the user's dwelling, in fact, in the broadcasting and transmitting network, which part is of primary importance for visualizing this audiovisual program on a TV or monitor screen but which has a very low volume in comparison to the total volume of the digital audiovisual program recorded at the user's dwelling. The lacking part will be transmitted via the broadcasting/transmitting network at the moment of viewing of this prerecorded digital audiovisual program at the user's dwelling.

The greatest part of the audiovisual stream will therefore be transmitted via a classic broadcasting network whereas the lacking part will be sent on demand via a narrow telecommunication band such a the classic telephone networks or cellular networks of the GSM, GPRS or UMTS type or using a small part of a network of the DSL or BLR type or also using a subset of the bandwidth divided on a cable network.

In The Attached Drawings:

FIG. 1 shows a basic scheme of a distribution system in accordance with the present invention.

FIG. 2 shows a particular embodiment of the system for stream analysis and synthesis in accordance with the invention.

FIG. 3 shows a particular embodiment of a system for stream synthesis in accordance with the invention.

In FIG. 1 the arrangement for video interfacing 8 is adapted to connect at least one display device, e.g., a monitor, a video projector or a device of the TV screen type 6 to at least one interface of a broadband transmission and broadcasting network 4 and to at least one telecommunication network interface 10. According to the present invention this arrangement is composed of module 8 mainly comprising on the one hand a processing unit adapted to process in particular decoding and descrambling all video streams of the MPEG-4 type according to a preloaded decoding and descrambling software program in such a manner as to display them in real or non-real time, store them, record and/or send them on a telecommunication network and comprising on the other hand at least one screen interface 7 and a connection interface to a local or wide area network 5 and/or 9. Broadband transmission and broadcasting network 4 and telecommunication network 10 can be combined into a single network.

The hard disk of module 8 can be used as buffer memory to instantaneously store at least a part of the program or of the video stream to be displayed in the case of time shift viewing or of limitation in the bandwidth of the transmission network. The viewing can be delayed or time-shifted upon the request of the user or of the portal 12.

As FIG. 1 shows, connection interface 5 is connected to a broadband transmission and broadcasting network 4 such as a modem, satellite modem, cable modem, fiber-optic line interface or to a radio or infrared interface for wireless communication.

The content of audiovisual programs such as films will be transmitted by this classic video broadcasting connection. Nevertheless, in order to not allow pirated copies to be made, a small part of the audiovisual content is retained in portal 12 before the audiovisual content is transmitted from server 1 or portal 12.

In the case of viewing an audiovisual program in real time this small part of the audiovisual content retained in portal 12 will also be sent to module 8 via telephone communication network 10.

Since the successive planes of a video sequence comprise a large number of identical visual elements (as in a movie, one image resembles the preceding one), MPEG-4 only registers the elements that differ from the original plane. Thus, an entire reference plane will be modified while retaining the modifications made to the differential movement detectors in portal 12, and it is not necessary for the successive planes depending on this reference plane I to add modifications since they would make the viewed stream diverge on account of disturbances added to planes P.

The MPEG-4 compression therefore begins at first by breaking down the image into different square matrices comprising several points or pixels, each one of which has its own calorimetric value. A calculation permits the obtention of an average value for each matrix in which each point is now embedded. This processing generates a pixelation and the appearance of solid colors where nuances of shade existed. The second stage of the MPEG-4 compression consists in retaining only the changing elements from one plane to the other.

In order to obtain animated images of the MPEG-4 type, the principle consists in capturing several images in time and the intermediate images are calculated from the latter. The analysis of the complete reference planes permits the prediction of intermediate planes P. Then, planes B are intercalated between reference planes and predicted planes.

The video is represented as a succession of individual planes, each of which is processed as a two-dimensional matrix of image elements (pixels). The representation of the colors of each pixel comprises three components; A luminance component Y and two chrominance components Cb and Cr.

The compression of the digital video is realized by using several techniques: Sampling of chrominance information for adaptation to the sensitivity of the human visual system (HVS), quantification, movement compensation (MC) for utilizing time-dependent redundancy, transformation into the frequency range by discrete cosine transformation (DCT) for utilizing the spatial redundancy, variable length coding (VLC) and interpolation of images.

Since the human visual system is most sensitive to the resolution of the luminance component of an image, the values of pixel Y are coded in full resolution. The human visual system is less sensitive to chrominance information. The sub-sampling eliminates the values of pixels based systematically on the position, which reduces the quantity of information to be compressed by other techniques. The standard retains a unit of chrominance pixels for each vicinity 2×2 of luminance pixels.

The base coding unit of an image is the macroblock. The macroblocks of each image are coded successively from left to right and from top to bottom. Each macroblock is composed of 6 8×8 blocks; four luminance blocks, one chrominance block Cb and one chrominance block Cr. Note that the four luminance blocks cover the same zone of the image as each of the chrominance blocks due to the sub-sampling of the chrominance information carried out in order to adapt the coding to the sensitivity of the human visual system.

For a given macroblock the first operation is the selection of the coding mode, which depends on the type of image, the effectiveness of the compensated movement prediction in the coded region and on the nature of the signal contained in the block. Secondly, a compensated movement prediction of the block content based on prior or future reference images is formed. This prediction is subtracted from the real data of the current macroblock in order to form an error signal. Thirdly, this error signal is divided into 6 8×8 blocks (4 luminance blocks and 2 chrominance blocks in each macroblock) to each of which a discrete cosine transformation is applied. The resulting 8×8 block of DCT coefficients is quantified. The two-dimensional block that results is scanned in zigzag in order to be converted into a one-dimensional chain of quantified DCT coefficients. Fourthly, the attached information of the macroblock (type, vectors, etc) as well as the data of the quantified coefficients is coded. In order to obtain maximum effectiveness, a certain number of coding tables with variable length are defined for the various data elements. A coding of the run lengths is applied to the data of the quantified coefficients.

The coefficient DCT of upper left point 0,0 of the block represents a zero horizontal and vertical frequency: It is called coefficient DC (continuous). As the coefficient DC is proportional to the average value of the pixels of block 8×8, the predictive coding permits a supplementary compression because the difference of the average values of the adjacent 8×8 blocks tends to be relatively small. The other coefficients represent one or several spatial horizontal and/or vertical frequencies that are not zero and are called AC coefficients. In order that the quantification level of the coefficients corresponding to the elevated spatial frequencies favors the creation of a zero coefficient, a quantification step such as the human visual system (VHS) is selected that has little chance of perceiving the loss of the spatial frequency concerned unless the value of the coefficient is above this quantification level. The statistical coding of the provided consecutive ranges of coefficients with an elevated order and zero value contributes considerably to the gain of compression. In order to regroup the non-zero coefficients at the beginning of the series and to code as many zero coefficients as possible following the last non-zero coefficient, their sequences given by a zigzag scanning that concentrates the elevated spatial frequencies at the end of the series.

Variable length coding (VLC) is a statistical coding technique that assigns code words to the values to be coded. Short code words are assigned to the frequency values that frequently occur and long code words to frequency values that do not occur frequently. On average, the more frequent short code words are in the majority in such a manner that the coded chain is shorter than the original data.

The invention consists in using and modifying the differential movement vectors of planes P and/or B and/or S in order to be able to manipulate the aspect and the visual validity of the sequence to which the planes in question belong.

According to a particular embodiment the complete MPEG-4 stream is analyzed by analyzing device 121 of portal 12; all the planes P are analyzed in order to find each of their differential movement vectors. For each value found the system proceeds to back it up in buffer 123 of portal 12 and it is replaced in the stream by the maximal value authorized by the norm, identically for each value found. The transformed stream is stored in output buffer 122. Its size is different from original stream 101 but it is perfectly readable by any user 8 capable of reading original stream 101.

According to a particular embodiment all planes P of complete MPEG-4 stream 101 are analyzed by analysis device 121 of portal 12 in order to find each of their differential movement vectors. In order to reduce the size of the backed-up data only the differential movement vectors of one macroblock of every two or three will be transformed. The means for finding the planes which were modified will be retained in buffer 12 of portal 12 with the original values of the transformed differential movement vectors.

According to a particular embodiment all planes P of complete MPEG-4 stream 101 are analyzed by analysis device 121 of portal 12 in order to find each of their differential movement vectors. In order to have a transformed stream with a size identical to original MPEG-4 stream 101 at the level of output buffer 122 only a certain number of bits are transformed into the VLC code representing the processed value so that the resulting VLC code respects the norm and that the new value is sufficiently removed from the original one in order that the transformation is the most efficient one possible.

According to a particular embodiment only one part of the planes of the original MPEG-4 stream 101 will be analyzed and transformed, thus permitting a reduction of the size of the data memorized in buffer 123 of portal 12.

When it reads the binary stream a classic MPEG-4 decoder identifies the beginning of a coded plane, then the type of the plane. In order to avoid any confusion between a standard decoder box, often called a set-top box or STB, the standard MPEG-4 decoder is called “reader” (player or viewer) in the remainder of this document. This reader can be realized in hardware and/or in software. The MPEG-4 successively decodes each macroblock of the plane. The plane is reconstructed when all its macroblocks have been processed. If it is a matter of a plane I it constitutes a reference plane for the subsequent planes and it is stored in the place of the oldest reference plane. Thus, the planes are available in digital form for post-processing and display as the application desires.

In the case of an audiovisual program of the MPEG-4 type all the characteristics of planes P coming from server 1 or portal 12 are not transmitted to module 8. In particular, the characteristics in conformity with the invention are the differential movement vectors contained in planes P.

Certain differential movement vectors of these planes P are retained in portal 12. In contrast thereto, instead of and in place of the non-transmitted differential movement vectors of these planes P the device in conformity with the invention intercalates false differential movement vectors with the same nature as the differential movement vectors removed and retained in portal 12 in such a manner that the standard MPEG-4 reader of module 8 is not disturbed by these modifications that it ignores and reconstitutes an output MPEG-4 stream at the output that is not correct from the viewpoint of a human being but correct from the viewpoint of the MPEG-4 format.

The MPEG-4 reader of box 8 is a standard MPEG-4 reader and is not modified or affected in any way by the changes made to planes P.

As FIG. 1 shows, connection interface 9 is connected to wide-area telecommunication network 10 directly or by a local network functioning as access network and is constituted, e.g., by a subscriber line interface (analog or digital telephone network, DSL, BLR, GSM, GPRS, UMTS, etc).

Thus, the audiovisual programs are broadcast in a classic manner in a broadcasting mode via broadband transmission network 4 of the microwave, cable, satellite, digital microwave, DSL, etc. type from server 1 directly via connection 3bis or portal 12 via connections 2, 3 to set-top box 8 via connection 5. Each audiovisual program broadcast in this manner can be encrypted or not encrypted and, in conformity with the present invention, the streams of the MPEG-4 type comprise modifications at the level of certain planes P and or B as described above. Certain audiovisual programs modified in this manner and incomplete are recorded on the hard disk of box 8 as a function of the parameters selected by the user or of information transmitted by the broadcasting server.

When the user desires to view an audiovisual program recorded in this manner onto the hard disk of his box 8, he makes the request for this in a classic manner by a remote control connected to his box 8 that is then automatically connected to portal 12 via connection 9 of the local network or direct access type and the telecommunication network 10 connected itself to portal 12 via connection 11. Connections 9, 11 remain established during the viewing of the audiovisual program and permit box 8 to receive the functions and parameters of recovery in the order of the modified differential movement vectors of planes P. The modified differential movement vectors of planes P transmitted in this manner are never recorded on the hard disk of box 8 because reconstituted planes P are directly displayed on viewing screen 6 via connection 7 after having been processed by the reader of box 8 from its local volatile memory. Once processed and viewed, the modified and/or lacking differential movement vectors of planes P that were transmitted by portal 12 will be deleted from the local volatile memory of box 8.

According to a particular embodiment the original values of the differential movement vectors of planes P broadcast in this manner can be encrypted or not encrypted by any existing or future encryption means. The same applies to the algorithms, the functions and parameters of recovery in the order of the modified differential movement vectors of planes P.

Each time that the user desires to view a program recorded in the hard disk of box 8, box 8 is automatically connected to portal 12. Likewise, when the user makes a pause, the transmission of the modified differential movement vectors of plane P coming from portal 12 will be interrupted until the viewing is resumed, thus guaranteeing that all the information of an audiovisual program is not located in box 8 at a given moment, thus preventing an ill-disposed person from making pirated copies of these recordings.

According to a particular embodiment box 8 comprises a smart card reader that allows portal 12 to authenticate the user who owns box 8.

According to a particular embodiment the smart card contains, for a given MPEG-4 content, said second stream that was memorized by portal 12.

If this has been authorized, the smart card also allows the user to make private copies of the audiovisual programs recorded on the hard disk of his set-top box 8. For this, if the user desires to make a private copy of an audiovisual program he will do so in a classic manner on a video cassette recorder via connection 7 which connects box 8 to viewing screen 6.

However, if he wishes to retain a private copy on the hard disk of his box, he will indicate this to his box 8, that will record the information “private copy” as well as the address of the user located on the smart card in a particular field 84 of this audiovisual program recorded on hard disk 85 of set-top box 8. Then, each time that the user wants to see this private copy, box 8 connects automatically to portal 12 and indicates to the latter that the user wants to read his private copy. In return, if the reading of the private copy is possible for this user who possesses this smart cart connected to this box 8, set-top box 8 then receives the modified and/or lacking differential movement vectors of planes P as well as all the other information allowing the viewing of the audiovisual program constituting the private copy.

According to another embodiment, if the user wants to retain a private copy on the hard disk of his box, he indicates this to the server that will record the information “private copy” for this program in the private copy memory 124 of portal 12 and for this user authenticated by the smart card. Then, every time that the user wants to see this private copy, box 8 connects automatically to portal 12 and indicates to it that the user wants to read his private copy. In return, if the reading of the private copy is possible for this user who possesses this smart cart and for this program, set-top box 8 then receives the lacking modified differential movement vectors of planes P as well as all the other information allowing the viewing of the audiovisual program constituting the private copy.

According to a particular embodiment the private copy can allow the user to view this very audiovisual program in an unlimited manner or a number of times determined in advance by the supplier of the service that authorized this private copy.

The present invention also relates to the physical box 8 used by the consumer for accessing the data. This physical box is situated in the home of the user. It supplies a number of functions that manage the information appropriate for presentation in accordance with the selection of the audience and manages the connection and the communication with the remote server.

According to a particular embodiment the physical box corresponding to video interface arrangement 8 is realized as an autonomous fixed device with an integrated hard disk.

According to a particular embodiment the physical box corresponding to video interface arrangement 8 is realized as an autonomous portable (mobile) device with an integrated hard disk and/or disk reader (CD, DVD, etc.).

According to a particular embodiment video interface arrangement 8 is realized as an additional part to be installed in a computer of the PC type and to be connected to at least one broadband transmission and broadcasting network interface 4 and to at least one telecommunication network interface 10. This card makes use of the hard disk of the PC computer in order to record the first stream but comprises its own computer and its own volatile memory in such a manner as not to allow an ill-disposed user of the PC the means to access complementary information such as the modified differential movement vectors of planes P of the second stream.

According to the present invention the video and multimedia servers 1 and/or 12 comprise means for coding, transcoding and scrambling video data, in particular means for adding cryptographic and security information at the beginning of and during the sequences.

Finally, it remains to be pointed out that the invention degrades the MPEG-4 stream from the visual viewpoint until it no longer allows the recognizing of the scenes transmitted and displayed without having access to the complementary data and characteristics but rather totally reconstitutes the MPEG-4 stream in video interface arrangement 8 without any loss.

Although the present invention is more particularly focused on audiovisual data, it is understood that all interactive multimedia information and all interactive data can be processed by the present arrangement and the present system and that the video data of the MPEG-4 type has been worked out the most.

The present invention will be better understood from the following description presenting the physical base of the present invention and making reference to FIG. 2 of the attached drawings representing a preferred embodiment of the invention by way of non-limiting realization that is particularly well-adapted for cable and satellite networks. The complete MPEG-4 stream is analyzed by analyzing device 121 of portal 12 and will thus be separated in a stream of the MPEG-4 type but whose one part or all the differential movement vectors of planes P will have been processed and that will be sent via output 122 of the portal to broadband broadcasting transmission network 4.

The other part of the modified MPEG-4 stream is memorized in buffer memory 122 of portal 12. Portal 12 retains the modifications made to this MPEG-4 stream by analyzer 121 of portal 12 in buffer memory 122 for each MPEG-4 stream broadcast in this manner. It is clearly indicated that for one and the same MPEG-4 input stream 101 the processing of the stream can be different for each user 8 and/or for each group of users 8. Thus, buffer memory 123 of portal 12 comprises a different memory zone for each user.

In the examples realized the differential movement vectors of certain planes P of MPEG-4 stream are modified for a first user; for a second user certain differential movement vectors of planes P and of certain planes B of the MPEG-4 stream are modified and in the third example device 8 is portable (mobile).

The different stages for this first user will now be described.

Portal 121 has selected MPEG-4 stream 101 that it must send to user 8 for being viewed off-line on his TV screen 6. This user is connected to a digital broadcasting cable network 4 and to an ADSL telecommunication network 10.

Analysis system 121 of portal 12 will thus read MPEG-4 entering stream 101 and every time that it detects a plane P it will break it down into macroblocks, then into blocks. This analysis allows it to recognize the differential movement vectors in the code and to substitute certain ones of them by random values in order to make the planes (and consequently the sequence) illegible for human viewing. The true values of the differential movement vectors will be stored in output buffer 123, that allows the reconstitution of the starting sequence in box 8 at a later time following the inverse scheme. In the realized example one macroblock of every two comprises a modified block (differential movement vectors).

Analysis system 121 then enters the value of the substituted coefficient of modified plane P into buffer 123. Analysis system 121 continues its analysis until the end of the input MPEG-4 stream.

The new modified MPEG-4 stream is then recorded in output buffer 122 in order to be broadcast on broadcasting network 4 via connection 5. The substituted differential movement vectors of modified planes P of entering MPEG-4 stream 101 are memorized in buffer 123 of portal 12.

During this time the modified MPEG-4 output stream coming from output buffer 122 of portal 12 is broadcast in a totally unsynchronized manner via broadband network 4 to one or several users 8.

Each authorized set-top box 8 that wishes to record this MPEG-4 stream modified in this manner can then read this MPEG-4 stream and record it on its hard disk 85. This recording initiative is left to decoder 8 under the control of portal 12. To this end, analysis system 121 had entered information about supplementary data at the beginning of the MPEG-4 stream that clarified the addressees of this modified MPEG-4 stream. The addressees can thus be a particular addressee 8 by himself, a group of addressees 8 or the totality of decoders 8 connected to network 4.

The phase described above corresponds to the first preparation phase of the MPEG-4 stream by portal 12, to its transmission via broadband network 4 and to its recording in decoder 8. This decoder can then display this MPEG-4 stream recorded on its hard disk 85. To this end synthesizing system 87 of decoder 8 will read the MPEG-4 file from its hard disk 85 and send it to a classic MPEG-4 reader 81. If no complementary data is received by synthesis system 87 the MPEG-4 stream coming to reader 81 is then processed and displayed as it is , which brings about a significant distortion of the display on viewing screen 6. In fact, modified planes P processed by synthesis system 87 do not correspond to planes P that are necessary for a correct viewing since certain differential movement vectors have been substituted by random differential movement vectors. On the other hand, as the recorded stream is a stream of the MPEG-4 type, reader 81 does nothing different and displays the information of output screen 6 that appear as data of an MPEG-4 video stream but totally incoherent to a human looking at screen 6. Every copy of MPEG-4 stream coming from hard disk 85 of box 8 will produce the same visual effect during its restitution by any MPEG-4 reader. Thus any ill-intentioned using of this copy will fail.

When the user of box 8 desires to view the audiovisual program recorded on his hard disk 85 in real time on his screen 6 he requests this from synthesis system 87 with his remote control as he would do with a VCR or a DVD player that presents a menu on his TV screen. Synthesis system 87 then makes a request to hard disk 85 and begins to analyze the modified MPEG-4 stream coming from hard disk 85 via reading buffer 83. Synthesis system 87 then establishes a connection with portal 12 via telecommunication network 10 that is, in our example, a DSL connection. Once this connection is established and during the entire duration of the viewing of the film or audiovisual program, synthesis system 87 retrieves the substituted differential movement vectors and the data corresponding to modified plane P of the stream recorded on hard disk 85 from buffer memory 123 of server 12. These differential movement vectors and this positional data come to synthesis system 87 via input buffer memory 86 and are temporarily stored in volatile memory 88 of synthesis system 87. Synthesis system 87 reconstitutes, in a manner that is inverse to the analysis process previously described, modified planes P by real planes P from the modified MPEG-4 stream arriving via buffer 83 and from the differential movement vectors and the associated data that arrives via buffer 86 into memory 88 and sends the new MPEG-4 stream reconstituted in this manner to reader 81 to be correctly displayed on screen 6. As soon as they have been used, the differential movement vectors to be substituted and the data associated with these planes P are deleted from volatile memory 88.

In the example realized, before portal 12 authorizes the sending of planes P and the associated data from its buffer 123, portal 12 has verified that the user of box 8 was properly authorized to do this. To this end portal 12 reads the information contained on smart card 82 of box 8 and verifies that this user is properly authorized to view this audiovisual program. The differential movement vectors in the associated data are only sent from buffer 123 to box 8 corresponding to this user via network 10 after this verification.

In the example realized, the user also made a private copy of his audiovisual program. Therefore, synthesis system 87 recorded complementary data as well as the number of smart card 82 and the information “private copy” on a part 84 of hard disk 85 as data associated with this audiovisual program. During the next private reading of this audiovisual program synthesis system 87 will analyze this associated data and thus inform portal 12 that the user of box 8 is reading the private copy. If this function is authorized for this user 8 by portal 12 the differential movement vectors and the associated data will then be sent by portal 12 to buffer 86 as described above. In the contrary case the differential movement vectors and the associated data will not be sent and the user of box 8 will not be able to view the reconstituted MPEG-4 stream.

The various steps for the second user 8 will now be described in detail.

In this second instance broadcasting network 4 is a satellite network and telecommunication network 10 is a low bandwidth cellular telephone system of the GSM type.

The user of box 8 will receive the MPEG-4 streams and the complementary data from portal 12 in a manner identical to the above description.

On the other hand, in the example realized, instead of modifying each plane P analysis system 121 only takes one plane P our of n where n is a random number between 1 and 12 and takes account of the B's. Thus, before sending the MPEG-4 stream from output buffer 122 analysis system 121 will read input MPEG-4 stream 101 and after drawing random number n the synthesis system modifies the differential movement vectors at the nth plane P of the MPEG-4 stream. After each plane P modified in this manner, analysis system 121 will make a new drawing of a random number n. Each random number used in this manner is recorded in buffer 123 of portal 12. For planes B analysis system 121 takes into account one plane B out of m where m is a random number between 1 and 5 in a frame for which plane P has not been modified.

Analysis system 121 of portal 12 reads input MPEG-4 stream 101 and each time that it detects an nth plane P or an mth plane B it breaks it down into macroblocks, then into blocks. This analysis allows it to recognize the differential movement vectors in the code and to substitute certain ones with random values in order to render the planes (and consequently the sequence) illegible for human viewing. The true values of the differential movement vectors are stored in output buffer 123 that permits the reconstitution of the starting sequence at a later date in box 8 following the inverse scheme.

Furthermore, in this second realized example all the differential movement vectors of this nth plane P will not be modified. Only one macroblock out of two comprises a modified block (differential movement vectors) while respecting the equality of the modification frequencies for the six blocks of one macroblock. Furthermore, the substitution of each differential movement vector is made by a differential movement vector calculated in a random manner, but its value is compared to the value of the differential movement vector to be substituted in such a manner as to verify its deviation. If this deviation is too small, another random number is calculated such a manner to as to increase the deviation between the vector to be substituted and the substituting vector.

The same applies to planes B.

For the reconstitution of the MPEG-4 stream box 8 reads buffers 86, 87 and decodes the data elements of the binary stream in conformity with the defined syntax.

When it reads the binary stream the box identifies the beginning of a coded plane then the plane type. It successively decodes each macroblock of the plane. The type of macroblock and the movement vectors are used to construct a prediction of the current macroblock based on the prior and future reference planes stored in the box. The data of the differential movement vectors is decoded. The result is added to the prediction signal with defined dynamics. Before sending the MPEG-4 stream to reader 81 synthesis system 87 replaces the differential movement vectors of planes P and B that were substituted by those of the stream coming from buffer 86.

During the reconstitution of the MPEG-4 stream by synthesis system 87 of box 8, the reading of these random numbers and of the differential movement vectors substituted from output buffer 123 of portal 12 and the reading of the MPEG-4 stream modified in this manner from hard disk 85 of box 8 allow synthesis system 87 to reconstitute planes P and B and to send the entirety to reader 81.

The plane is reconstructed by reader 81 when all these macroblock have been processed. If a plane P or a plane B is concerned, it constitutes a reference plane for the subsequent planes and it is stored in place of the old reference plane. In the example realized for this user it was determined that the second stream required a bandwidth lower than one thousandth of the bandwidth necessary for transmitting the high-quality MPEG-4 stream 4 or less than 1 kb per second for the second stream compared to 1 Mb per second for the first MPEG-4 stream.

The various stages for this third user will now be described in detail.

In this embodiment the MPEG-4 stream is processed by analysis stream 12 in the same manner as the MPEG-4 stream of the second realization.

However, the first modified MPEG-4 stream is entered and recorded on a physical support 20 of the CD type from the output buffer memory of analysis system 12.

The second stream is memorized in buffer 123 and is also recorded in addition on a physical support 10b is with the format of a credit card constituted by a smart card and a flash memory. This card 10 b is will be read by card reader 82 of device 8. Device 8 is an autonomous, portable and mobile system. In the realization device 8 comprises synthesis system 87, standard MPEG-4 reader 81, the two buffer memories 86 and 83 as well as disk reader 85.

Moreover, device 8 comprises integrated screen 6b is of the flat screen type that allows the user to directly view its audiovisual programs on its autonomous device 8.

In order to view an audiovisual program of the MPEG-4 type the user of device 8 introduces a disk 20b is of type 20 identical to the one recorded by analysis system 12 into his disk player 85. This disk 20b is thus contains an MPEG-4 stream of the first stream type, that is to say, with the differential movement vectors of certain substituted planes P and/or B.

The user of device 8 can therefore view this MPEG-4 stream on his screen 6b is integrated into his device. However, the MPEG-4 stream will not be correct from the visual viewpoint on account of the substitution of the differential movement vectors. In order to render the stream correct visually, the user introduces memory card 10b is containing the second stream with the differential movement vectors into smart card reader 82. The synthesis system then reconstitutes the correct MPEG-4 stream from the first stream coming from disk 20b is and from the second stream coming from card 10b is connected to reader 82.

In a particular arrangement smart card 10b is contains the data and the differential movement vectors of several second streams for the reconstitution of several MPEG-4 streams.

In a particular arrangement device 8 comprises a cellular connection to a GSM network 10.

1. A process for the distribution of video sequences according to a nominal stream format intended to describe a plurality of audiovisual scenes, each scene being constituted by a plurality of hierarchical audiovisual objects and by a describer of this hierarchy and spatial and temporal relationships between these objects with each video object comprising at least one digital plane p, characterized in that an analysis of the stream is carried out before the transmission to the client equipment in order to generate a first modified stream presenting the format of a nominal stream and whose planes P, B or S (GMC) contain macroblocks of which all or part of the values of the movement vectors were modified, and to generate a second stream with any format, comprising digital information suitable for permitting the reconstruction of these modified planes, that the two streams generated in this manner are then transmitted separately from the server to the addressed equipment and that a synthesis of a stream to the nominal format is calculated on the addressed equipment as a function of this first stream and of this second stream:

2. A process for the distribution of video sequences according to claim 1, characterized in that the format of the nominal stream is defined by the MPEG-4 norm.

3. A process for the distribution of video sequences according to claim 1, characterized in that this first modified stream presents planes P, B or S (GMC) of which all or a part of the movement vectors were modified by the substitution of certain values of the movement vectors by values of the same nature but random and that this second stream comprises the values of the substituted movement vectors and digital information suitable for allowing the reconstruction of these modified planes.

4. A process for the distribution of video sequences according to claim 1, characterized in that this analysis decides the values of the movement vectors to be modified as a function of the desired size for this second stream and of the degradation desired for this modified first stream.

5. A process for the distribution of video sequences according to claim 1, characterized in that the transmission of this first stream is realized via a broadband network (cable, satellite, digital microwave, fiber-optic, DSL (digital subscriber line), BLR (local radio loop) or DAB (digital audio broadcasting).

6. A process for the distribution of video sequences according to claim 1, characterized in that the transmission of this second stream is realized via a switched telephone network (analog or digital RTC) or via a network of the DSL (digital subscriber line) type or via a BLR (local radio loop) or via a mobile telephone network using the GMS, GPRS or UMTS norms.

7. A process for the distribution of video sequences according to claim 1, characterized in that the transmission of this second stream is realized via a support material distributed physically (flash memory card, smart card).

8. Equipment for the production of a video stream for carrying out the process according to claim 1, comprising at least one multimedia containing the original video sequences and characterized in that it comprises a device for analyzing the video stream coming from this server in order to generate the two streams.

9. A system for transmitting a video stream according to claim 1, characterized in that it comprises equipment for producing a video stream, at least one piece of equipment for using a video stream, and at least one communication network between the production equipment and the piece(s) of equipment for use.

10. A process for distributing video sequences according to a nominal stream format that describes a plurality of audiovisual scenes, each scene formed from a plurality of hierarchical audiovisual objects and a describer of the hierarchy and spatial and temporal relationships between the objects, with each video object comprising at least one digital plane P, comprising:
analyzing the nominal stream to generate a first modified stream having a format of the nominal stream and having planes P, B or S (GMC) containing macroblocks of which all or part of values of movement vectors were modified,
generating a second stream with any format comprising digital information to permit reconstruction of the modified planes, separately transmitting the two streams from the server to addressed equipment, and
calculating a synthesis of a stream to the nominal format on the addressed equipment as a function of the first and second streams.

11. The process according to claim 10, wherein the format of the nominal stream is defined by a MPEG-4 norm.

12. The process according to claim 10, wherein the first modified stream has planes P, B or S (GMC) of which all or a part of movement vectors were modified by substitution of certain values of the movement vectors by values of the same nature, but random and the second stream comprises values of the substituted movement vectors and digital information that allows reconstruction of the modified planes.

13. The process according to claim 10, wherein the analysis decides values of the movement vectors to be modified as a function of a desired size for the second stream and degradation desired for the modified first stream.

14. The process according to claim 10, wherein transmission of the first stream is via a broadband network.

15. The process according to claim 10, wherein transmission of the second stream is via a switched telephone network or a mobile telephone network using GMS, GPRS or UMTS norms.

16. The process according to claim 10, wherein transmission of the second stream is realized via a support material distributed physically.

17. Equipment for producing a video stream for carrying out the process according to claim 10, comprising at least one multimedia containing original video sequences and a device that analyzes the video stream coming from the server to generate the two streams.

18. A system for transmitting a video stream according to claim 10, comprising equipment for producing a video stream, at least one piece of equipment for using a video stream, and at least one communication network between the production equipment and the piece(s) of equipment for use.
